(19) United States
(12) Patent Application Publication
(10) Pub. No.: US 2012/0065839 A1
(43) Pub. Date: Mar. 15, 2012

(54) COMMUNICATIONS SYSTEM FOR VEHICLE

(75) Inventors: Masahiro MAKINO, Aichi (JP); Shinichi YOSHIDA, Aichi (JP); Osamu INAGAKI, Aichi (JP)

(73) Assignee: KABUSHIKI KAISHA TOKAI RIKA DENKI SEISAKUSHO, Aichi (JP)

(21) Appl. No.: 13/227,243

(22) Filed: Sep. 7, 2011

(30) Foreign Application Priority Data
Sep. 13, 2010 (JP) 2010-204641

(51) Int. Cl. G06F 7/00

(52) U.S. Cl. 701/36

(57) ABSTRACT

A communications system for a vehicle includes control units, that receive supply of electricity from an on-vehicle battery to control devices mounted on the vehicle and are connected to each other via a controller area network (CAN). Each control unit monitors operational states of the other control units. At least one of the control units has a power management module. The power management module monitors signals on the CAN to detect a signal indicating whether or not the at least one control unit needs to be activated, and, based on the detected signal, the power management module adjusts the amount of electricity supplied from the battery to the at least one control unit.

### BACKGROUND OF THE INVENTION

The present invention relates to a communications system for a vehicle that manages interactions between components driven by supply of electricity from the battery mounted on the vehicle.

In recent years, types of vehicles have been increasing that are equipped with systems designed for improving safety and operability such as an antilock brake system (ABS) and an electric power steering (EPS), and systems designed for improving convenience such as a keyless operation system (KOS). Since these systems are operated by consuming electricity stored in the vehicle battery, efficient use of the electricity have been researched. Vehicles that use a motor as a drive source, as opposed to an engine, have been developed. Such vehicles are generally called electric vehicles. A typical electric vehicle has various electronic control units (ECU) storing information regarding the vehicle and battery. Through exchange of data among these ECUs, charging of the battery from an external electricity source is controlled.

A communications system that performs such charging control is disclosed in “iMiEV, New Model Guide” published on Jul. 1, 2009 by Mitsubishi Motors, p. 54D-38, 54D-39. FIG. 5 shows the communications system described in the New Model Guide.

In a communications system 50, when an external electricity source 51 is connected to an on-vehicle charger 52, electricity is supplied from the external electricity source 51 to the on-vehicle charger 52. The on-vehicle charger 52 has a charger circuit 52a. The on-vehicle charger 52 uses electricity supplied to the charger circuit 52a to generate a charge activation signal for activating an EV-ECU 53.

The on-vehicle charger 52 and the EV-ECU 53 are connected to each other via a controller area network (CAN). When receiving electricity, the on-vehicle charger 52 generates a charge activation signal to the EV-ECU 53 via the CAN.

The EV-ECU 53 has a backup electricity source 53a. When receiving the charge activation signal, the EV-ECU 53 uses electricity stored in the backup electricity source 53a to turn on an EV control relay 54. Accordingly, the EV-ECU 53 is electrically connected to a battery 55 for auxiliary devices, and electricity is supplied to the EV-ECU 53 from the auxiliary device battery 55. This activates the EV-ECU 53.

The activated EV-ECU 53 turns on an on-vehicle charger relay 56. Accordingly, the on-vehicle charger 52 is electrically connected to the auxiliary device battery 55, and electricity is supplied to the on-vehicle charger 52 from the auxiliary device battery 55. This activates the on-vehicle charger 52. The activated on-vehicle charger 52 activates the charger circuit 52a.

At this time, the EV-ECU 53 measures the voltage and current of the electricity supplied to the charger circuit 52a from the external electricity source 51 via the CAN. From the measured values of the electricity, the EV-ECU 53 calculates a voltage value and a current value suitable for charging a driving battery 57, and send a command signal for, for example, raising the supplied voltage, to the on-vehicle charger 52 via the CAN. Based on the command signal from the EV-ECU 53, the charger circuit 52a supplies electricity to the driving battery 57 by, for example, raising the voltage from the external electricity source 51. The driving battery 57 is thus charged.

In the communications system 50, the on-vehicle charger 52 and the EV-ECU 53 are activated when the electricity source 51 and the on-vehicle charger 52 are connected to each other. That is, the on-vehicle charger 52 and the EV-ECU 53 consume electricity from the auxiliary device battery 55 only during charging of the driving battery 57. When charging is not being performed, the EV control relay 54 and the on-vehicle charger relay 56 are turned off so that electricity supply to the on-vehicle charger 52 and the EV-ECU 53 is stopped. Therefore, compared to a case where the EV control relay 54 and the on-vehicle charger relay 56 are not provided, the communications system 50 reduces the dark current.

However, being mechanical switches, the EV control relay 54 and the on-vehicle charger relay 56 can be mounted on limited positions in the vehicle. That is, the degree of freedom in mounting the EV control relay 54 and the on-vehicle charger relay 56 in the vehicle is limited. In this regard, improvement has been desired.

### SUMMARY OF THE INVENTION

Accordingly, it is an objective of the present invention to provide a communications system for a vehicle that reduces dark current without being limited by the design constraint of the vehicle.

To achieve the foregoing objective and in accordance with one aspect of the present invention, a communications system for a vehicle is provided. The system includes a battery mounted on a vehicle, a plurality of control units that receive supply of electricity from the battery and control devices mounted on the vehicle, an on-vehicle network, and a power management module. The on-vehicle network connects the battery and the control units with each other, and is used for monitoring operational states of the control units. The power management module is provided in at least one of the control units. The power management module monitors signals on the on-vehicle network to detect a signal indicating whether or not the at least one control unit needs to be activated. Based on the detected signal, the power management module adjusts the amount of electricity supplied from the battery to the at least one control unit.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram showing a communications system for a vehicle according to one embodiment of the present invention;

FIG. 2 is a block diagram showing the inner system of an EV-ECU and a keyless operation system (KOS);

FIG. 3 is a block diagram showing the inner system of the on-vehicle charger of FIG. 1;

FIG. 4 is a block diagram showing the inner system of the body control module (BCM) of FIG. 1; and

FIG. 5 is a block diagram schematically showing a conventional communications system for a vehicle.

### DETAILED DESCRIPTION OF THE PREFERRED EMBODIMENTS

A communications system 1 for a vehicle according to one embodiment of the present invention will now be described with reference to the drawings. The system 1 is mounted on an electric vehicle.

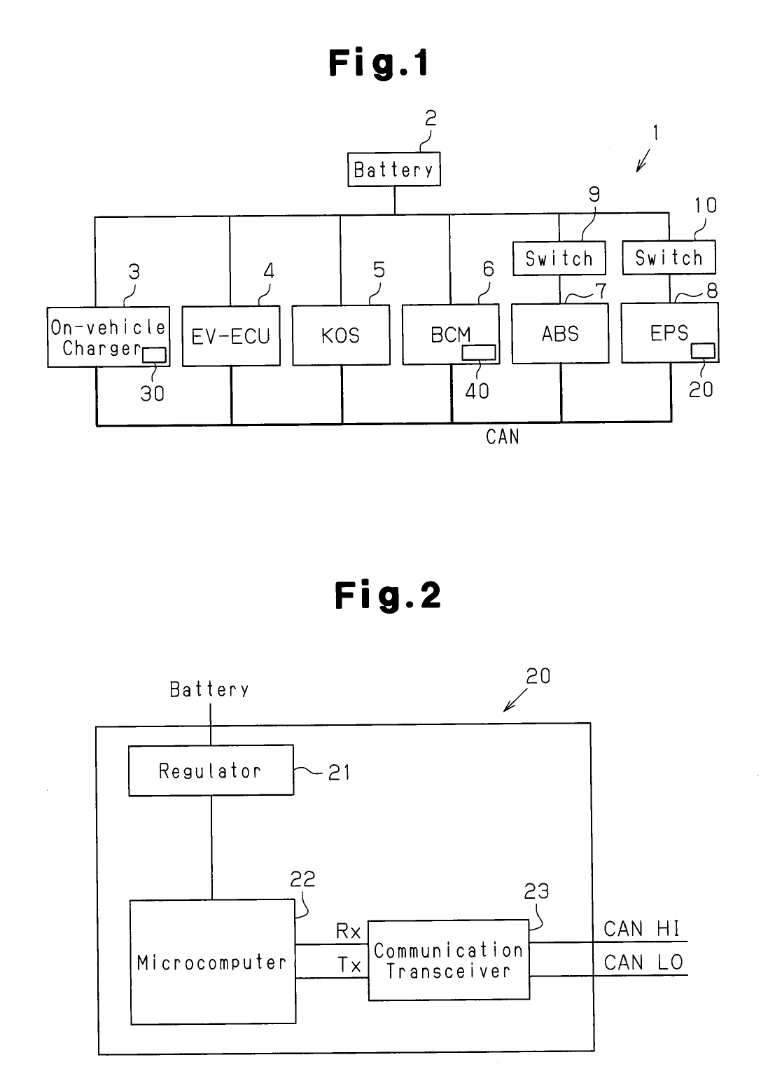

As shown in FIG. 1, the communications system 1 includes a battery 2 and a control unit including an on-vehicle charger 3, an EV-ECU 4 a keyless operation system (KOS) 5, a body control module (BCM) 6, an antilock brake system (ABS) 7, and an electric power steering (EPS) 8, which are connected in parallel with the battery 2. The on-vehicle charger 3 charges the battery 2 with electricity supplied from an unillustrated external electricity source (an alternating-current source). The on-vehicle charger 3 has an unillustrated charger circuit. The on-vehicle charger 3 uses the charger circuit, for example, to convert alternating-current electricity to direct-current electricity and to increases the voltage. The EV-ECU 4 electronically controls a motor that is the drive source of the vehicle and monitors the electricity stored in the battery 2. The KOS 5 performs transmission and reception of wireless signals between the vehicle and an electronic key, thereby permitting locking/unlocking of the vehicle doors or starting of the drive source. The BCM 6 detects open/close states of the unillustrated vehicle doors and the charger lid and shows the detected states using illumination. The BCM 6 also controls locking and unlocking of the doors. The ABS 7 prevents the tires from being locked, shortens the sudden braking distance of the vehicle, and prevents side skid of the vehicle. The EPS 8 assists steering operation performed by the user.

Each control unit is activated by electricity stored in the battery 2 and performs the corresponding control. These control units are connected to each other by the CAN, so that information is transmitted among the control units through the network. On the power line of the vehicle, a switch 9 is provided between the battery 2 and the ABS 7, and a switch 10 is provided between the battery 2 and the EPS 8. The ABS 7 and the EPS 8 need to operate only during operation of the drive source of the vehicle. Thus, the switches 9, 10 are turned on only when the vehicle drive source is operating, so as to supply the electricity from the battery 2 to the ABS 7 and the EPS 8. On the other hand, no switches are provided for the on-vehicle charger 3, the EV-ECU 4, the KOS 5, and the BCM 6. These components therefore always receives the electricity from the battery 2.

An inner system 20 of each of the EV-ECU 4, the KOS 5, the ABS 7, and the EPS 8 is shown in FIG. 2. As shown in FIG. 2, the inner system 20 is formed by an regulator 21 electrically connected to the battery 2 (see FIG. 1), a microcomputer 22 serving as control means or a control section electrically connected to the regulator 21, and a transceiver 23 connected to the microcomputer 22 via two signal lines Rx, Tx. The signal line Rx is used for reception, and the signal line Tx is used for transmission. The transceiver 23 is connected to transceivers 23 of other control units performing other control via the CAN.

The regulator 21 always controls the voltage value of the electricity from the battery 2 to be a constant value, and outputs the controlled electricity to the microcomputer 22. When supplied with electricity, the microcomputer 22 is activated and performs control corresponding to each control unit. The microcomputer 22 sends the own control information to the transceiver 23 via the signal line Tx. The transceiver 23 converts the information sent from microcomputer 22, that is, the electric signal, into a differential signal, which contains CAN-HI (High speed) and CAN-LO (Low speed), and sends the differential signal to the CAN. Also, when receiving a differential signal on the CAN, the transceiver 23 converts the received signal into a serial signal, and sends the serial signal to the microcomputer 22 via the signal line Rx. The control state of the microcomputer 22 in each control unit is monitored by the other control units.

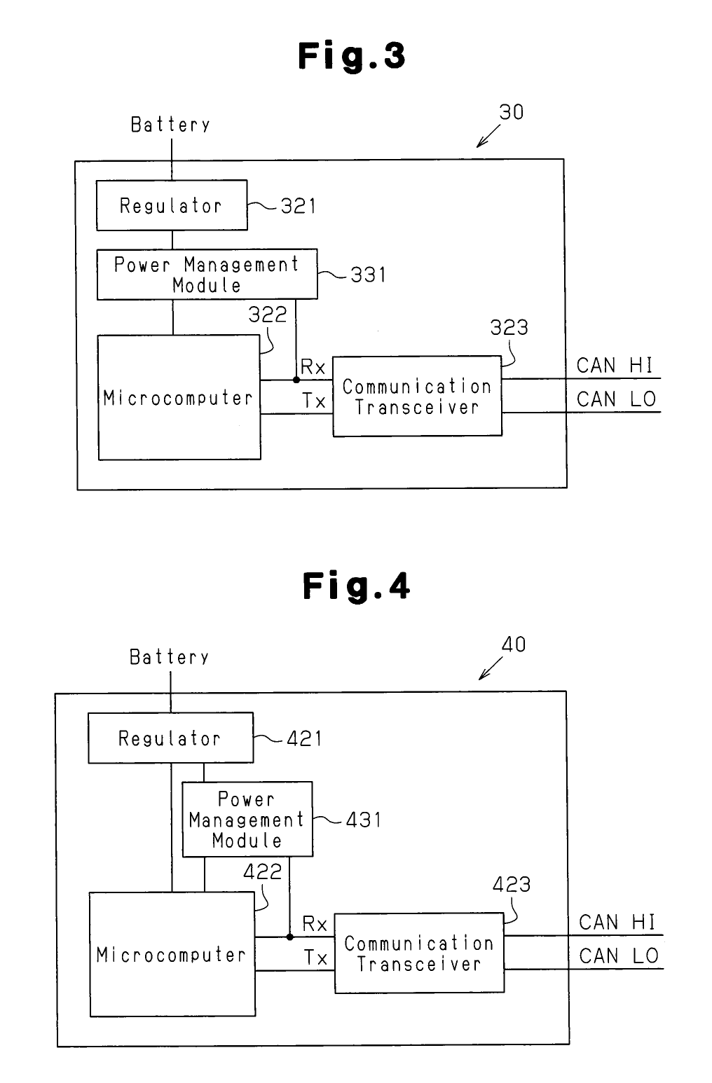

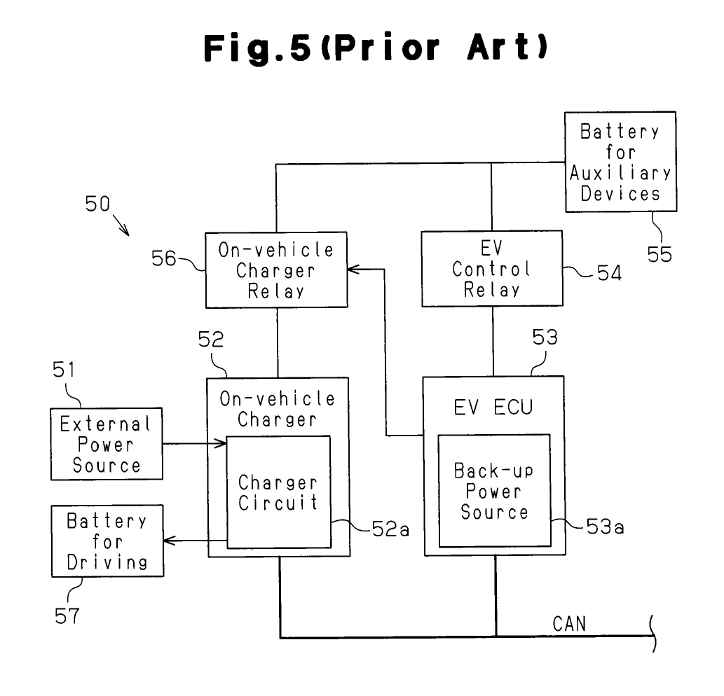

An inner system 30 of the control unit of the on-vehicle charger 3 is shown in FIG. 3. As shown in FIG. 3, the inner system 30 is formed by adding a power management module 331 to the inner system 20 shown in FIG. 2. To facilitate illustration and to avoid confusion with the regulator 21, the microcomputer 22, and the transceiver 23 of the inner system 20, a regulator, a microcomputer, and a transceiver of the inner system 30 are designated with reference numerals, 321, 322, and 323, respectively.

The power management module 331 is located between and electrically connected to the regulator 321 and the microcomputer 322. The power management module 331 is connected to the signal line Rx, which connects the microcomputer 322 and the transceiver 323 with each other. The on-vehicle charger 3 is connected to an unillustrated charger circuit connected to the microcomputer 322. The charger circuit is controlled by the microcomputer 322 to convert alternating-current electricity from the external electricity source to direct-current electricity and to increases supplied voltage.

The power management module 331 is activated by receiving electricity supplied from the regulator 321 and monitors signals on the signal line Rx to control the electricity supplied from the regulator 321 to the microcomputer 322. That is, in response to a signal indicating the open/close state of the charger lid, which is controlled by the BCM 6, the power management module 331 switches the microcomputer 322 selectively between an energized state and a nonenergized state.

An inner system 40 of the control unit of the BCM 6 is shown in FIG. 4. As shown in FIG. 4, the inner system 40 is formed by adding a power management module 431 to the inner system 20 shown in FIG. 2. To facilitate illustration and to avoid confusion with the regulator 21, the microcomputer 22, and the transceiver 23 of the inner system 20, a regulator, a microcomputer, and a transceiver of the inner system 40 are designated with reference numerals, 421, 422, and 423, respectively.

The power management module 431 of the inner system 40 is connected to the microcomputer 422 and the signal line Rx, while remaining connected to the regulator 421 and the microcomputer 422. That is, the microcomputer 422 always receives the electricity from the regulator 421 (constantly energized state).

The power management module 431 is activated by receiving the electricity supplied from the regulator 421, and monitors signals on the signal line Rx. Accordingly, the power management module 431 switches the microcomputer 422, which is always energized, between a sleep state, which is a standby state (power-saving mode), and a wake state, in which the microcomputer 422 detects the open/close state of the vehicle doors and controls illumination. In response to a signal of the KOS 5, which indicates the locked/unlocked state, the power management module 431 switches the microcomputer 422 selectively between the sleep state and the wake state. The sleep state is a state in which the microcomputer 422 stands by to be smoothly shifted to the wake state, and electricity consumption in the sleep state is less than that in the activated state. Since the sleep state is a standby state, the electricity consumption is reduced. In the wake state, illumination is performed. Therefore, compared to the sleep state, more electricity is consumed.

Electricity control performed by the above described communications system 1 will now be described. Suppose that the drive source of the vehicle is not operating, that is, the vehicle is parked. Therefore, the switches 9, 10 are off. Also, suppose that the vehicle doors and the charger lid are closed and locked.

The microcomputer 22 of each of the EV-ECU 4 and the KOS 5 is supplied with electricity from the corresponding regulator 21. The microcomputers 22 of the respective control units each perform control related to its function, and mutually monitors the control states of the others via the CAN.

At this time, the microcomputer 422 of the BCM 6 and the microcomputer 322 of the on-vehicle charger 3, which receive the control state of the other control units from the signal line Rx via the CAN, are each in the nonenergized state, or the sleep state. Accordingly, the electricity consumption at the microcomputers 322, 422 is reduced. The information of signals sent to the microcomputers 322, 422 of the on-vehicle charger 3 and the BCM 6 via the CAN is monitored by the power management module 331, 431, respectively.

In a case where the vehicle is parked, if the user attempts to charge the battery 2, an external electricity source needs to be connected to the vehicle (the on-vehicle charger 3). That is, the unillustrated charger led needs to be unlocked and opened.

The locking/unlocking of the charger lid is detected by the KOS 5. Therefore, if the charger lid is unlocked, a signal indicating the unlocked state is transmitted to the microcomputers 22, 322, 422 of the other control units via the CAN.

The signal indicating that the charger lid has been unlocked is also transmitted to the microcomputer 422 via the transceiver 423 of the BCM 6 and the signal line Rx. At this time, the power management module 431, which monitors the signal line Rx, acknowledges the signal indicating that the charger lid has been unlocked. Based on the signal, the power management module 431 determines that the user will soon open the charger lid, and switch the microcomputer 422 in the sleep state to the wake state. The microcomputer 422 in the wake state consumes more electricity than in the sleep state and performs illumination to indicate the position of the charger lid.

The open/close state of the charger lid is detected by the microcomputer 422 of the BCM 6. Therefore, if the charger lid is opened, a signal indicating the open state is transmitted to the microcomputers 22 of the other control units via the CAN.

The signal indicating that the charger lid has been opened is also transmitted to the microcomputer 322 via the transceiver 323 of the on-vehicle charger 3 and the signal line Rx. At this time, the power management module 331, which monitors the signal line Rx, acknowledges the signal indicating that the charger lid has been opened. Based on the signal, the power management module 331 determines that the user will soon charge the battery 2 from the external electricity source, and energizes the microcomputer 322, which has been in the nonenergized state. That is, the power management module 331 supplies the electricity that has been controlled to a predetermined voltage by the regulator to the microcomputer 322. The microcomputer 322 is thus energized and activated. In this state, when the external electricity source is connected to the vehicle, the microcomputer 322 detects the connection and measures the voltage value and current value of the electricity supplied from the external electricity source. The microcomputer 322 calculates the value of voltage increase required for charging the battery 2 with the electricity from the connected electricity source, and controls an unillustrated charger circuit. In this manner, the alternating-current electricity supplied from the external electricity source passes through the charger circuit to be converted into direct-current electricity and to have its voltage raised before charging the battery 2.

In this manner, the on-vehicle charger 3 has the power management module 331, which allows the on-vehicle charger 3 to activate the microcomputer 322 provided therein using opening of the charge lid as a trigger. In the first place, the microcomputer 322 of the on-vehicle charger 3 is control means that needs to be activated only when the battery 2 is charged. Therefore, by activating the microcomputer 322 only when the battery 2 is charged, the electricity consumed by the microcomputer 322 is reduced when the battery 2 is not being charged. That is, consumption of the electricity stored in the battery 2 is reduced.

When the battery 2 is being charged by the external electricity source, illuminations are not necessary. Therefore, the microcomputer 322 provided in the on-vehicle charger 3 of the present embodiment sends to the CAN a signal for putting the microcomputer 422 of the BCM to the sleep state. When detecting the signal for switching to the sleep state, the power management module 431 of the BCM 6 switches the microcomputer 422 to the sleep state. This reduces the electricity consumption by the BCM 6 (the microcomputer 422) during charging.

When charging is complete and the vehicle is disconnected from the external electricity source, the microcomputer 322 of the on-vehicle charger 3 sends to the CAN a signal indicating that illumination needs to be performed. When detecting the signal, the power management module 431 of the BCM 6 quickly switches the microcomputer 422 to the wake state. This causes the microcomputer 422 to execute necessary illumination.

Thereafter, when the charger lid is closed, the microcomputer 322 of the on-vehicle charger 3 no longer needs to be activated. Therefore, the microcomputer 422 of the BCM 6 transmits via the CAN a signal for switching the microcomputer 322 to the nonenergized state. When detecting the signal for switching the microcomputer 322 to the nonenergized state, the power management module 331, which monitors the signal line Rx, stops the supply of electricity from the battery 2 to the microcomputer 322 of the on-vehicle charger 3. The microcomputer 322 thus stops using the electricity stored in the battery 2.

Also, when the charger lid is locked, the microcomputer 422 of the BCM 6 no longer needs to be in the wake state. Therefore, the microcomputer 22 of the KOS 5 transmits via the CAN a signal for switching the microcomputer 422 to the sleep state. When detecting the signal for switching the microcomputer 422 to the sleep state, the power management module 431, which monitors the signal line Rx, put the microcomputer 422 to the sleep state, thereby reducing the electricity consumption by the microcomputer 422. The microcomputer 422 thus reduces its consumption of the electricity stored in the battery 2.

As described above, the preferred embodiment has the following advantages.

(1) The on-vehicle charger 3 has the power management module 331. By monitoring a signal indicating the open/close state of the charger lid that is sent from the CAN to the microcomputer 322 of the on-vehicle charger 3, the power management module 331 selectively switches the microcomputer 322 between the energized state and the nonenergized state. Accordingly, the microcomputer 322 is supplied with electricity from the battery 2 only when the charger lid is open, that is, only when the external electricity source and the vehicle can be connected to each other. Thus, the microcomputer 322 receives electricity only when it needs to be activated. This reduces the electricity consumed by the microcomputer 322. Therefore, unlike the conventional art, the vehicle does not need to mount a relay, which is a mechanical switch for reducing the electricity consumed by the microcomputer 22 of the on-vehicle charger. This increases the degree of freedom in mounting the battery 2 and the on-vehicle charger 3 in the vehicle.

(2) The BCM 6 has the power management module 431. By monitoring a signal indicating the locking/unlocking of the charger lid that is sent from the CAN to the microcomputer 422 of the BCM 6, the power management module 431 selectively switches the microcomputer 422 between the sleep state and the wake state. The microcomputer 422 consumes less electricity in the sleep state than in the wake state. Therefore, the consumption of electricity at the microcomputer 422 is reduced by putting the microcomputer 422 in the wake state only when the charger lid is unlocked and control for turning on illumination is executed.

(3) When the on-vehicle charger 3 is charging the battery 2 using the external electricity source, the power management module 331 of the on-vehicle charger 3 sends to the CAN a signal for putting the microcomputer 422 of the BCM, which does not need to be activated during charging, to the sleep state. This puts the microcomputer 422 to the sleep state during charging, and therefore reduces the consumption of electricity at the BCM 6 (the microcomputer 422) during charging.

The above-described embodiment may be modified as follows.

In the illustrated embodiment, the power management module 331 is provided in the on-vehicle charger 3, and the power management module 431 is provided in the BCM 6, power management modules may be provided in other control units, that is, the EV-ECU 4, the KOS 5, the ABS 7, and the EPS 8. In this case, all the control units may have an inner system 30 or an inner system 40. This configuration reduces the consumption of electricity at control units provided with a power management module. In a case where the ABS 7 and the EPS 8 have a power management module, the switches 9, 10 can be omitted.

In the illustrated embodiment, the on-vehicle charger 3 has the inner system 30 shown in FIG. 3. However, the on-vehicle charger 3 may have the inner system 40 shown in FIG. 4. This also reduces the consumption of electricity at the on-vehicle charger 3.

In the illustrated embodiment, the BCM 6 has the inner system 40. However, the BCM 6 may have an inner system 30. This also reduces the consumption of electricity at the BCM 6.

In the illustrated embodiment, the present invention is applied to a vehicle that mounts control units including the on-vehicle charger 3, the EV-ECU 4, the KOS 5, the BCM 6, the ABS 7, and the EPS 8. However, the present invention may be applied to vehicles having other control units. Other control units include, for example, a motor control unit (MCU), a battery management unit (BMU), a cell monitor control unit (CMU), a compressor, a heater controller, and a meter.

1. A communications system for a vehicle, the system comprising:
a battery mounted on a vehicle;
a plurality of control units that receive supply of electricity from the battery and control devices mounted on the vehicle;
an on-vehicle network connecting the battery and the control units with each other, the on-vehicle network being used for monitoring operational states of the control units; and
a power management module provided in at least one of the control units,
wherein the power management module monitors signals on the on-vehicle network and detects a signal indicating whether or not the at least one control unit needs to be activated, and, based on the detected signal, the power management module adjusts the amount of electricity supplied from the battery to the at least one control unit.

2. The communications system for a vehicle according to claim 1, wherein
each of the control units includes a regulator for maintaining the electricity from the battery to a constant value and a control section that is activated in response to the electricity from the regulator,
the operational states of the at least one control unit include an energized state, in which electricity is supplied to the control section, and a nonenergized state, in which supply of electricity to the control section is stopped, and
the power management module is provided between the regulator and the control section and switches the at least one control unit selectively between the energized state and the nonenergized state, thereby adjusting the supply of electricity from the battery to the at least one control unit.

3. The communications system for a vehicle according to claim 1, wherein
each of the control units includes a regulator for maintaining the electricity from the battery to a constant value and a control section that is activated in response to the electricity from the regulator,
the operational states of the at least one control unit include a wake state, in which the control section is in an activated state and a predetermined amount of electricity is consumed, and a sleep state, in which the control section stands by to smoothly shift to the activated state and the amount of consumed electricity is less than that in the wake state, and
the power management module is provided between the regulator and the control section and switches the at least one control unit selectively between the wake state and the sleep state, thereby adjusting the supply of electricity from the battery to the at least one control unit.

4. The communications system for a vehicle according to claim 2, wherein
the at least one control unit includes an on-vehicle charger that controls charging of the battery by an external electricity source, and
the power management module is provided in the on-vehicle charger and detects a signal related to execution of charging of the battery by the external electricity source, thereby detecting a signal indicating whether or not the on-vehicle charger needs to be activated.

5. The communications system for a vehicle according to claim 1, wherein
the power management module is provided in one of the control units that does not need to be activated when the battery is being charged by the external electricity source, and
the control unit that is activated during the charging transmits, to the on-vehicle network, a signal for reducing the amount of electricity supplied to the control unit that does not need to be activated during the charging.
